(19) United States
(12) Patent Application Publication
(10) Pub. No.: US 2012/0030021 A1
(43) Pub. Date: Feb. 2, 2012

(54) SELECTING ADVERTISEMENTS USING SAME SESSION QUERIES

(75) Inventors: Ankur K. Gupta, Sunnyvale, CA (US); Arun Kumar Gnanamani, Mountain View, CA (US)

(73) Assignee: YAHOO! INC., Sunnyvale, CA (US)

(21) Appl. No.: 12/848,822

(22) Filed: Aug. 2, 2010

(51) Int. Cl. G06Q 30/00; G06F 17/30

(52) U.S. Cl. 705/14.53; 707/723; 707/E17.014

(57) ABSTRACT

Techniques are described herein for selecting an advertisement using same session queries. Each occurrence of a query is referred to as a query instance. When a query instance is received from a user, that query instance and other query instances that were received from the user prior to that query instance (i.e., historical query instances) are taken into consideration to select an advertisement to be provided to the user. The query instance in response to which the advertisement is to be provided and the historical query instances that are received at respective time instances that do not precede a threshold time instance are referred to collectively as a session of the user. Accordingly, the session of the user may be described generally as a collection of query instances that are most recently received from the user.

### BACKGROUND OF THE INVENTION

1. Field of the Invention

The present invention relates to online advertising.

2. Background

Certain advertisement (“ad”) networks enable ads (e.g., contextual ads, sponsored ads, display ads, etc.) to be served to users who visit the Web sites of publishers that are participating in the ad network. Advertisers generate the ads and buy placements (a.k.a. inventory) for those ads on the publishers' Web sites usually based on the anticipated audiences for those sites and/or the content of those sites. A placement represents a publisher's agreement to serve a trafficked (i.e., specified) ad to users when the users visit the publisher's site. The publisher often serves the trafficked ad contemporaneously with other content associated with the publisher's site. For instance, sponsored search advertising systems commonly serve sponsored ads (e.g., sponsored search results) to users who enter queries on search engine websites, often alongside algorithmic search results that are provided in response to those queries.

Ad networks typically include ad serving systems that determine which advertisements are to be provided to users. In conventional ad networks, when a publisher receives a page view or a search query from a user, the publisher sends an ad call to an ad serving system. An ad call is a request for an advertisement. The ad serving system selects an advertisement from an ad inventory based on various factors. The query that is used by the ad serving system to select the advertisement depends on the configuration of the ad serving system. The advertisement traditionally is selected based on a single query of the user. For example, the ad serving system may be configured to select the advertisement based on the user's most recent query. The ad serving system then sends the advertisement to the publisher, so that the publisher can serve the advertisement to the user.

Selecting an advertisement based on a single query of a user may result in selection of a marginally relevant (or irrelevant) advertisement. For example, the search query may include uncommon terminology (e.g., a product model number) that may result in few matches from the ad inventory. In another example, the query may be navigational in nature, meaning that the query is provided by the user in an effort to navigate to a particular Web destination. In yet another example, the query may be inherently ambiguous (e.g., may include relatively few terms) and difficult to accurately match advertisements against. Moreover, search engine users typically use multiple queries that are spread over time to obtain information that they are seeking.

### BRIEF SUMMARY OF THE INVENTION

Various approaches are described herein for, among other things, selecting an advertisement using same session queries. Each occurrence of a query is referred to as a query instance. When a query instance is received from a user, that query instance and other query instances that were received from the user prior to that query instance (i.e., historical query instances) are taken into consideration to select an advertisement to be provided to the user. The query instance in response to which the advertisement is to be provided and the historical query instances that are received at respective time instances that do not precede a threshold time instance are referred to collectively as a session of the user. Accordingly, the session of the user may be described generally as a collection of query instances that are most recently received from the user.

Features are generated based on the query instances that are included in the session of the user. A feature of a query instance includes information regarding the query instance. Some example types of features include but are not limited to a keyword feature, a key phrase feature, a bid phrase feature, etc. A keyword feature of a query instance specifies a word that is included in the query instance. A key phrase feature of a query instance specifies two or more adjacent words in the query instance. A bid phrase feature of a query instance specifies a bid phrase that is associated with the query instance. A bid phrase is a phrase that is intended to trigger a specified advertisement. The bid phrase that is associated with the query instance need not necessarily be included in the query instance. For instance, the bid phrase may be generated or derived based on the query instance. Weights are assigned to the respective features based on recency of the query instances on which the respective features are based. An advertisement is selected to be provided to the user based on the features and the weights that are assigned to those features.

An example method of selecting an advertisement is described. In accordance with this example method, first features are generated based on a first query instance that is received from a user at a first time instance. First weights are assigned to the respective first features. Second features are generated based on historical query instances that are received from the user at respective historical time instances that precede the first time instance. Second weights are assigned to the respective second features. Each second weight is based on a duration of a period of time between a reference time instance and the historical time instance that corresponds to the historical query instance on which the respective second feature is based. Each of the second weights is compared to a threshold weight to determine whether the respective second weight is less than the threshold weight. The second features are updated to not include each second feature to which a respective second weight is assigned that is less than the threshold weight. The second weights are updated to not include second weights that are less than the threshold weight. The first and second features are combined to provide third features. The first and second weights are combined to provide third weights that correspond to the respective third features. An advertisement is selected to be provided to the user based on the third features and the respective third weights in response to the first query instance.

Another example method of selecting an advertisement is described. In accordance with this example method, first features are generated based on a first query instance that is received from a user at a first time instance. First weights are assigned to the respective first features. Each historical time instance at which a respective historical query instance is received from the user is compared to a threshold time instance to determine designated query instances. The designated query instances include the historical query instances except historical query instances that are received from the user at historical time instances that precede the threshold time instance. The historical time instances precede the first time instance. Second features are generated based on the designated query instances. Second weights are assigned to the respective second features. Each of the second weights is based on a duration of a period of time between a reference time instance and the historical time instance that corresponds to the designated query instance on which the respective second feature is based. The first and second features are combined to provide third features. The first and second weights are combined to provide third weights that correspond to the respective third features. An advertisement is selected to be provided to the user based on the third features and the respective third weights in response to the first query instance.

An example system is described that includes a feature generator, a weight assignment module a weight comparison module, a feature update module, a weight update module, a feature combination module, a weight combination module, and an ad selection module. The feature generator is configured to generate first features based on a first query instance that is received from a user at a first time instance. The feature generator is further configured to generate second features based on historical query instances that are received from the user at respective historical time instances that precede the first time instance. The weight assignment module is configured to assign first weights to the respective first features. The weight assignment module is further configured to assign second weights to the respective second features. Each of the second weights is based on a duration of a period of time between a reference time instance and the historical time instance that corresponds to the historical query instance on which the respective second feature is based. The weight comparison module is configured to compare each of the second weights to a threshold weight to determine whether the respective second weight is less than the threshold weight. The feature update module is configured to update the second features to not include each second feature to which a respective second weight is assigned that is less than the threshold weight. The weight update module is configured to update the second weights to not include second weights that are less than the threshold weight. The feature combination module is configured to combine the first and second features to provide third features. The weight combination module is configured to combine the first and second weights to provide third weights that correspond to the respective third features. The ad selection module is configured to select an advertisement to be provided to the user based on the third features and the respective third weights in response to the first query instance.

Another example system is described that includes a time comparison module, a feature generator, a weight assignment module, a feature combination module, a weight combination module, and an ad selector. The time comparison module is configured to compare each historical time instance at which a respective historical query instance is received from a user to a threshold time instance to determine designated query instances. The designated query instances include the historical query instances except historical query instances that are received from the user at historical time instances that precede the threshold time instance. The feature generator is configured to generate first features based on a first query instance that is received from the user at a first time instance. The feature generator is further configured to generate second features based on the designated query instances. The historical time instances precede the first time instance. The weight assignment module is configured to assign first weights to the respective first features. The weight assignment module is further configured to assign second weights to the respective second features. Each of the second weights is based on a duration of a period of time between a reference time instance and the historical time instance that corresponds to the designated query instance on which the respective second feature is based. The feature combination module is configured to combine the first and second features to provide third features. The weight combination module is configured to combine the first and second weights to provide third weights that correspond to the respective third features. The ad selection module is configured to select an advertisement to be provided to the user based on the third features and the respective third weights in response to the first query instance.

Further features and advantages of the disclosed technologies, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example advertisement (“ad”) network in accordance with an embodiment described herein.

FIGS. 2A-2B depict respective portions of a flowchart of an example method for selecting an advertisement in accordance with an embodiment described herein.

FIGS. 3A-3C depict respective portions of a flowchart of another example method for selecting an advertisement in accordance with an embodiment described herein.

FIG. 4 depicts a flowchart of yet another example method for selecting an advertisement in accordance with embodiments described herein.

FIG. 5 is a block diagram of an example implementation of an ad selector shown in FIG. 1 in accordance with an embodiment described herein.

FIGS. 6 and 8 show some example advertisements that are selected to be provided to a user in response to respective queries that are received from the user in accordance with embodiments described herein.

FIG. 7 illustrates absence of advertisements when same session queries are not used to select advertisements in accordance with an embodiment described herein.

FIG. 9 is a block diagram of a computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

Example embodiments are capable of selecting an advertisement using same session queries. Each occurrence of a query is referred to as a query instance. When a query instance is received from a user, that query instance and other query instances that were received from the user prior to that query instance (i.e., historical query instances) are taken into consideration to select an advertisement to be provided to the user. The query instance in response to which the advertisement is to be provided and the historical query instances that are received at respective time instances that do not precede a threshold time instance are referred to collectively as a session of the user. Accordingly, the session of the user may be described generally as a collection of query instances that are most recently received from the user.

Features are generated based on the query instances that are included in the session of the user. A feature of a query instance includes information regarding the query instance. Some example types of features include but are not limited to a keyword feature, a key phrase feature, a bid phrase feature, etc. A keyword feature of a query instance specifies a word that is included in the query instance. A key phrase feature of a query instance specifies two or more adjacent words in the query instance. A bid phrase feature of a query instance specifies a bid phrase that is associated with the query instance. A bid phrase is a phrase that is intended to trigger a specified advertisement. The bid phrase that is associated with the query instance need not necessarily be included in the query instance. For instance, the bid phrase may be generated or derived based on the query instance. Weights are assigned to the respective features based on recency of the query instances on which the respective features are based. An advertisement is selected to be provided to the user based on the features and the weights that are assigned to those features.

Techniques described herein have a variety of benefits as compared to conventional techniques for selecting an advertisement to be provided to a user. For example, by selecting an advertisement using same session queries, intent of a user may be more efficiently and/or more accurately disambiguated. Techniques described herein may provide a richer and/or more diverse ad experience. The techniques may use a combination of query features that is more monetizable than a combination of features that is based only on the user's most recent query. The techniques may provide an opportunity to cross-sell relevant advertisements.

In one example scenario, a user may have an overall goal of planning a vacation trip to Las Vegas. A variety of tasks may be performed to achieve the overall goal. For example, the user may book flights, hotels, car rentals, find restaurants, and so on. To accomplish these tasks, the user may issue the following search queries in succession within a common session:

1) cheap flights to Las Vegas

2) Las Vegas hotels

3) car rentals

4) restaurants in strip.

If these queries are treated independently, the user may see ads only for flights, hotels, car rentals, or restaurants in response to each respective query. Moreover, the car rental ads that the user sees may be local car rental ads that are based on the user's location, because no geographic context is given in the user's search query of “car rentals”. Furthermore, the independent selection of ads in response to the search query of “restaurants in strip” may not be capable of correlating “strip” with Las Vegas, resulting in selection of ads for local restaurants based on the user's location. Accordingly, treating the queries independently may not provide a rich user experience, considering that the user is attempting to accomplish the overall goal by tailoring individual search queries to complete the associated tasks.

However, if ads are selected using same session queries, context from previous queries of the session is incorporated into the selection of ads for the present query. For example, when ads are selected for each of the “car rental” and “restaurants in strip” search queries, the phrase “Las Vegas” from the “cheap flights to Las Vegas” and “Las Vegas hotels” search queries is taken into consideration for selection of the ads. For instance, an ad that offers a flight and hotel package deal to Las Vegas may be selected in response to the query “Las Vegas hotels”. An ad that offers car rentals at the Las Vegas airport may be selected in response to the query “car rentals”.

Moreover, selecting the ads using same session queries facilitates cross-selling of relevant ads. For instance, ads regarding Las Vegas hotels may be shown to the user in response to the user's “car rentals” and/or “restaurants in strip” search queries.

In another example scenario, a user may be looking for home-based part-time or full-time opportunities. To achieve this goal, the user may issue the following search queries in succession within a common session:

1) work from home

2) home based business

3) home based working moms

4) making money online

5) cheap money online.

The first three search queries of this session indicate that the user intends to find a home-based business opportunity. The intention of the last two search queries shifts toward online opportunities, but the original intention is still relevant. By using same session queries, a determination may be made that the user is looking for some kind of online-oriented work-from-home opportunity for a mom.

### II. Example Embodiments

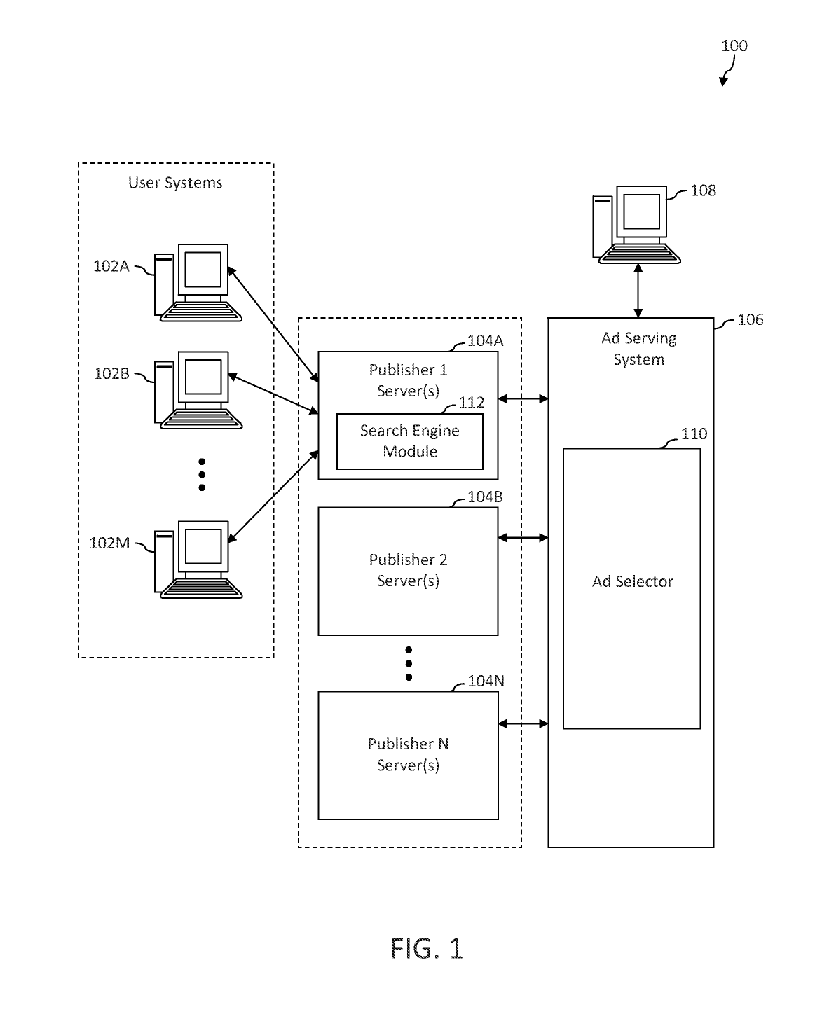

FIG. 1 is a block diagram of an example advertisement (“ad”) network in accordance with an embodiment described herein. Generally speaking, ad network 100 operates to serve ads (e.g., contextual ads, sponsored ads, display ads, etc.) provided by advertisers to sites (e.g., Web sites) published by publishers when such sites are accessed by certain users of the network, thereby delivering the ads to the users. For instance, the ads may be served in response to search queries that are received from the users. As shown in FIG. 1, ad network 100 includes a plurality of user systems 102A-102M, a plurality of publisher servers 104A-104N, an ad serving system 106, and at least one advertiser system 108. Communication among user systems 102A-102M, publisher servers 104A-104N, ad serving system 106, and advertiser system 108 is carried out over a network using well-known network communication protocols. The network may be a wide-area network (e.g., the Internet), a local area network (LAN), another type of network, or a combination thereof.

User systems 102A-102M are computers or other processing systems, each including one or more processors, that are capable of communicating with any one or more of publisher servers 104A-104N. For example, each of user systems 102A-102M may include a client that enables a user who owns (or otherwise has access to) the user system to access sites (e.g., Web sites) that are hosted by publisher servers 104A-104N. For instance, a client may be a Web crawler, a Web browser, a non-Web-enabled client, or any other suitable type of client. By way of example, each of user systems 102A-102M is shown in FIG. 1 to be communicatively coupled to publisher 1 server(s) 104A for the purpose of accessing a site published by publisher 1. Persons skilled in the relevant art(s) will recognize that each of user systems 102A-102M is capable of connecting to any of publisher servers 104A-104N for accessing the sites hosted thereon.

Publisher servers 104A-104N are computers or other processing systems, each including one or more processors, that are capable of communicating with user systems 102A-102M. Each of publisher servers 104A-104N is configured to host a site (e.g., a Web site) published by a corresponding publisher 1-N so that such site is accessible to users of network 100 via user systems 102A-102M. Each of publisher servers 104A-104N is further configured to serve advertisements (e.g., contextual ads, sponsored ads, display ads, etc.) to users of network 100 when those users access a Web site that is hosted by the respective publisher server.

Publisher servers 104A-104N are further configured to execute software programs that provide information to users in response to receiving requests, such as hypertext transfer protocol (HTTP) requests, from users, instant messaging (IM) applications, or web-based email. For example, the information may include Web pages, images, other types of files, output of executables residing on the publisher servers, IM chat sessions, emails, etc. In accordance with this example, the software programs that are executing on publisher servers 104A-104N may provide Web pages that include interface elements (e.g., buttons, hyperlinks, etc.) that a user may select for accessing the other types of information. The Web pages may be provided as hypertext markup language (HTML) documents and objects (e.g., files) that are linked therein, for example.

One type of software program that may be executed by any one or more of publisher servers 104A-104N is a Web search engine. For instance, publisher 1 server(s) 104A is shown to include search engine module 112, which is configured to execute a Web search engine. Search engine module 112 is capable of searching for information on the World Wide Web (WWW) based on queries that are provided by users. For example, search engine module 112 may search among publisher servers 104A-104N for requested information. Upon discovering instances of information that are relevant to a user's query, search engine module 112 ranks the instances based on their relevance to the query. Search engine module 112 provides a list that includes each of the instances in an order that is based on the respective rankings of the instances. The list may be referred to as the search results corresponding to the query.

Search engine module 112 is configured to provide an ad call to ad serving system 106, upon receiving a query from a user, to request an advertisement (e.g., a contextual ad, a sponsored ad, a display ad, etc.) to be provided to the user. Search engine module 112 forwards a user identifier that corresponds to (e.g., that specifies) the user to ad serving system 106. For example, the user identifier may include a browser cookie of the user or information that is included in the browser cookie. In another example, the user identifier may include a username and/or an Internet Protocol (IP) address that is associated with the user. Search engine module 112 may incorporate the user identifier in the ad call or may provide the user identifier in addition to the ad call.

It will be recognized that a search engine module (e.g., search engine module 112) need not necessarily be included in publisher server(s) in order for the publisher server(s) to provide an ad call to ad serving system 1016. For instance, any one or more of publisher servers 104A-104N may provide an ad call to ad serving system 106 without utilizing a search engine module.

Ad serving system 106 is a computer or other processing system, including one or more processors, that is capable of serving advertisements (e.g., contextual ads, sponsored ads, display ads, etc.) that are received from advertiser system 108 to each of publisher servers 104A-104N when the sites hosted by such servers are accessed by certain users, thereby facilitating the delivery of such advertisements to the users. For instance, ad serving system 106 may serve advertisement(s) to a publisher server 104 in response to an ad call that is received from that publisher server 104. The ad call may be initiated in response to a query instance that is provided by a user. Ad serving system 106 may select an appropriate advertisement to be provided to the user based on a user identifier that is received from search engine module 112.

Ad serving system 106 includes an ad selector 110. Ad selector 110 is configured to select an advertisement (e.g., a contextual ad, a sponsored ad, a display ad, etc.) using historical query instances of a user that are included in the same session of the user that includes the query instance in response to which the advertisement is to be provided. Ad selector 110 receives an ad call that is based on the user's query instance from a publisher server 104. The ad call requests an advertisement to be displayed to the user. Ad selector 110 receives a user identifier that corresponds to the user from the publisher server 104. The user identifier may be included in the ad call or may be received in addition to the ad call. Ad selector 110 may use the user identifier to determine historical query instances of the user. For instance, ad selector 110 may access a look-up table and compare the user identifier with information (e.g., metadata) stored in the look-up table that is associated with query instances to determine which of the query instances are historical query instances of the user.

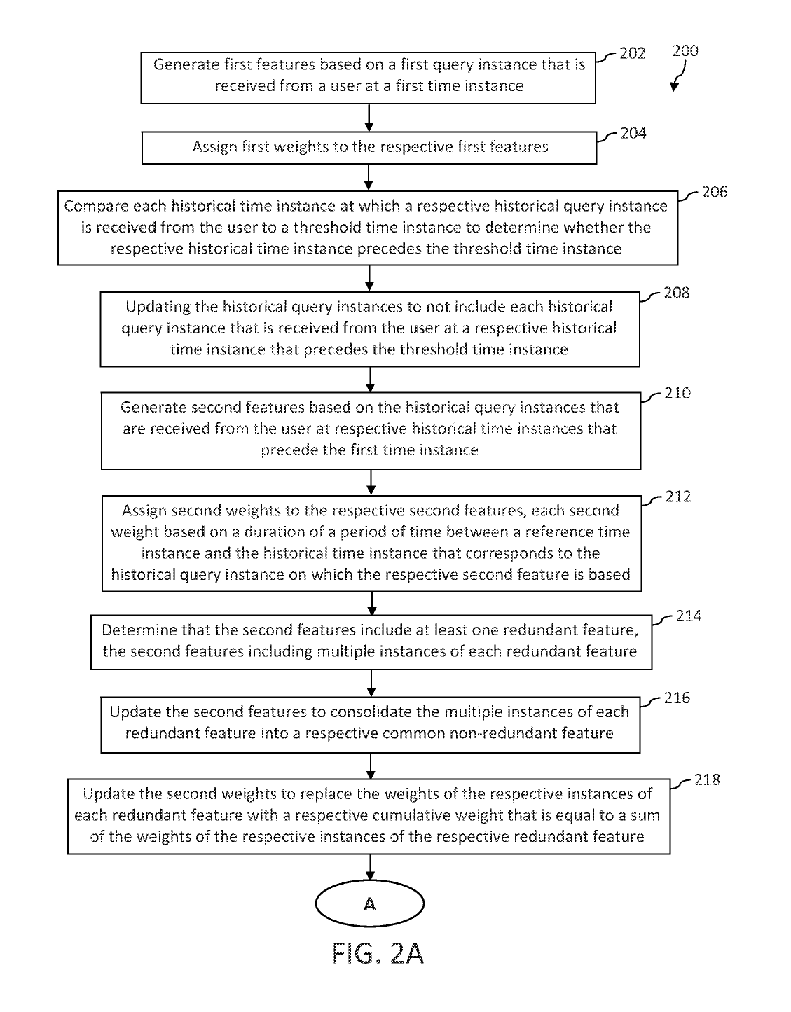

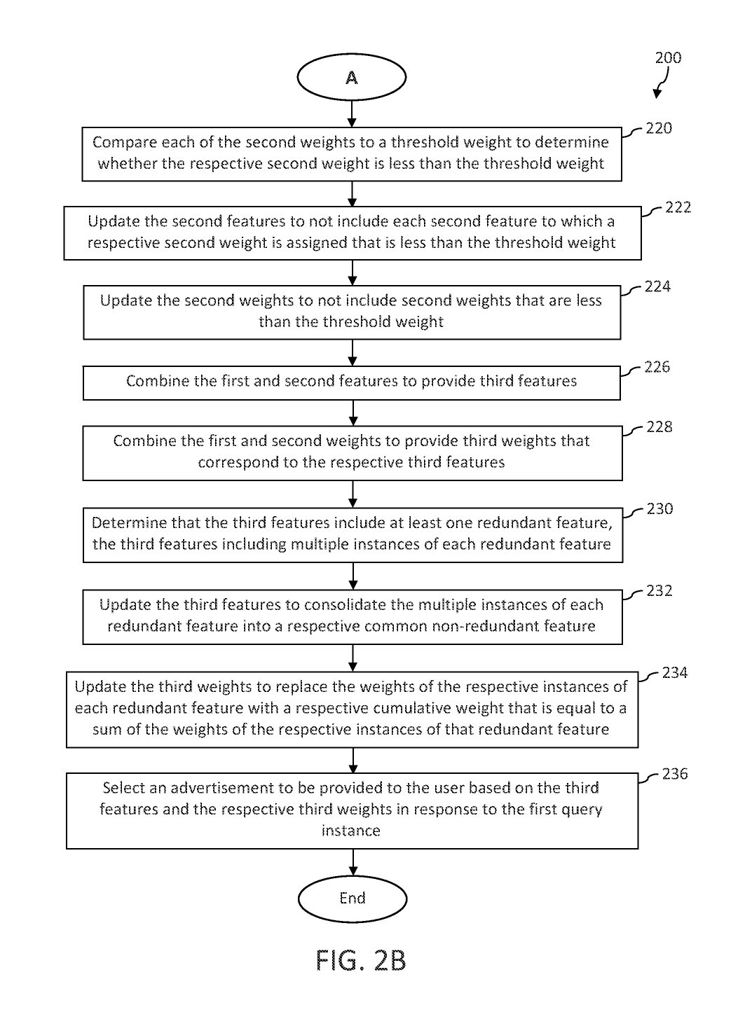

Ad selector 110 generates a first set of features (e.g., keywords and/or key phrases) based on the query instance that triggers the ad call (i.e., the query instance in response to which the advertisement is to be provided). Ad selector 110 generates a second set of features based on the historical query instances of the user. Ad selector 110 assigns a respective weight to each feature that is included in the first set of features and to each feature that is included in the second set of features. Each of the weights that is assigned to a respective feature in the second set is based on a recency of the historical query instance on which the respective feature is based. Ad selector 110 selects an advertisement to be provided to the user based on the features in the first set and their respective weights and the features in the second set and their respective weights. Techniques for selecting an advertisement are described in further detail below with reference to FIGS. 2A-2B, 3A-3C, and 4-8.

Advertiser system 108 is a computer or other processing system, including one or more processors, that is capable of providing advertisements (e.g., contextual ads, sponsored ads, display ads, etc.) to ad serving system 106, so that the advertisements may be served to publisher servers 104A-104N when the sites hosted by the respective servers are accessed by certain users. Although one advertiser system 108 is depicted in FIG. 1, persons skilled in the relevant art(s) will recognize that any number of advertiser systems may be communicatively coupled to ad serving system 106.

Although advertiser system 108 and user systems 102A-102M are depicted as desktop computers in FIG. 1, persons skilled in the relevant art(s) will appreciate that advertiser system 108 and user systems 102A-102M may include any browser-enabled system or device, including but not limited to a laptop computer, a tablet computer, a personal digital assistant, a cellular telephone, or the like.

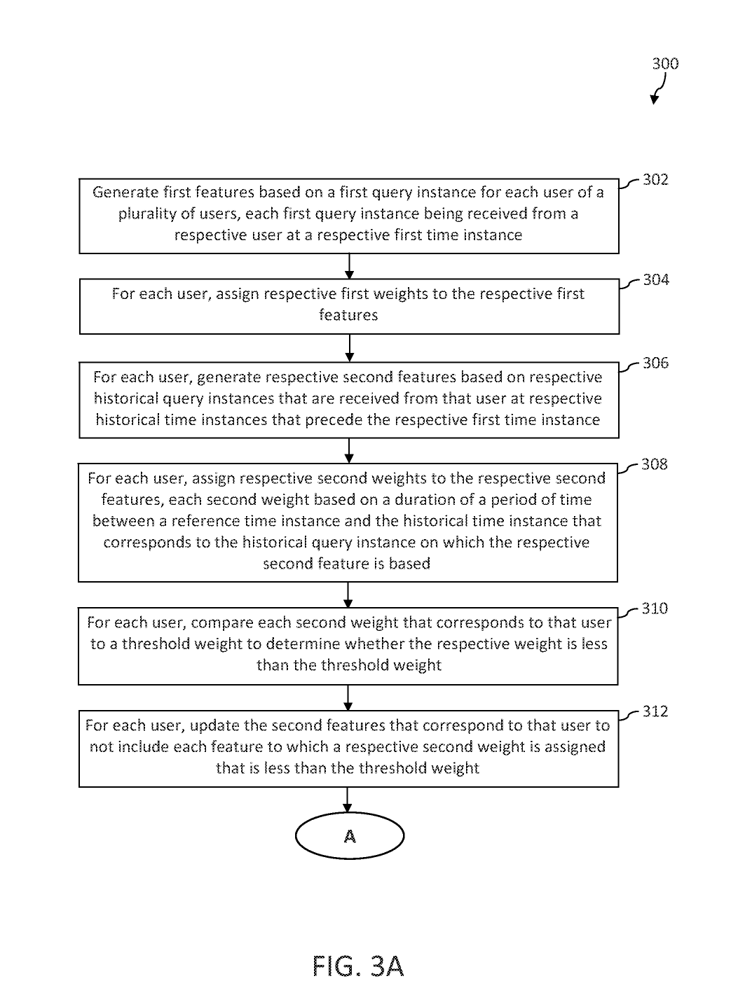

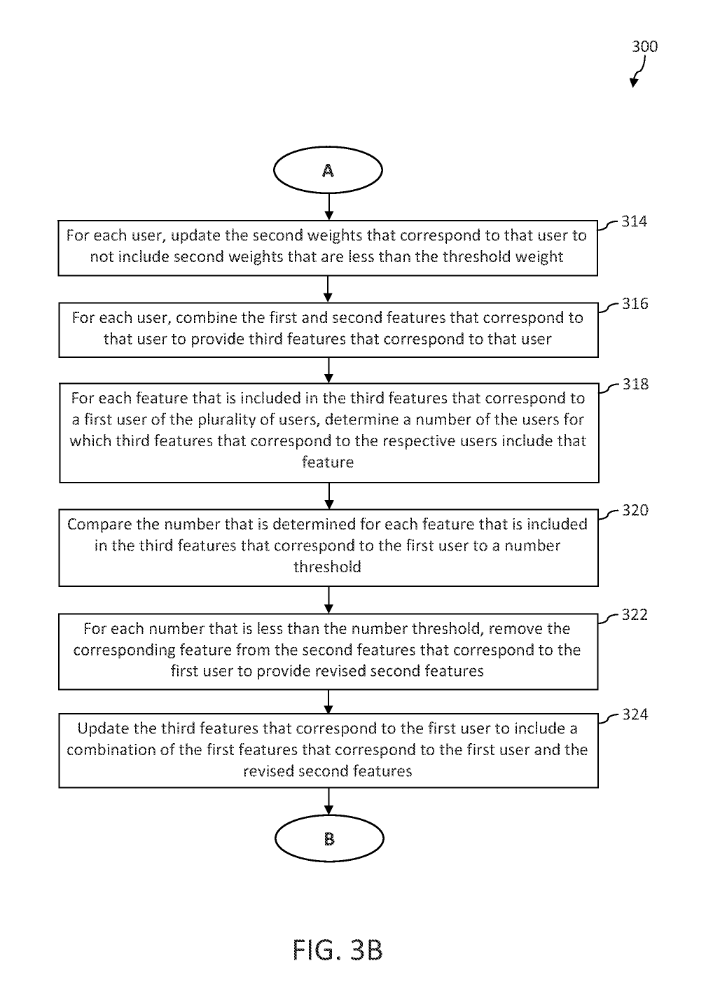

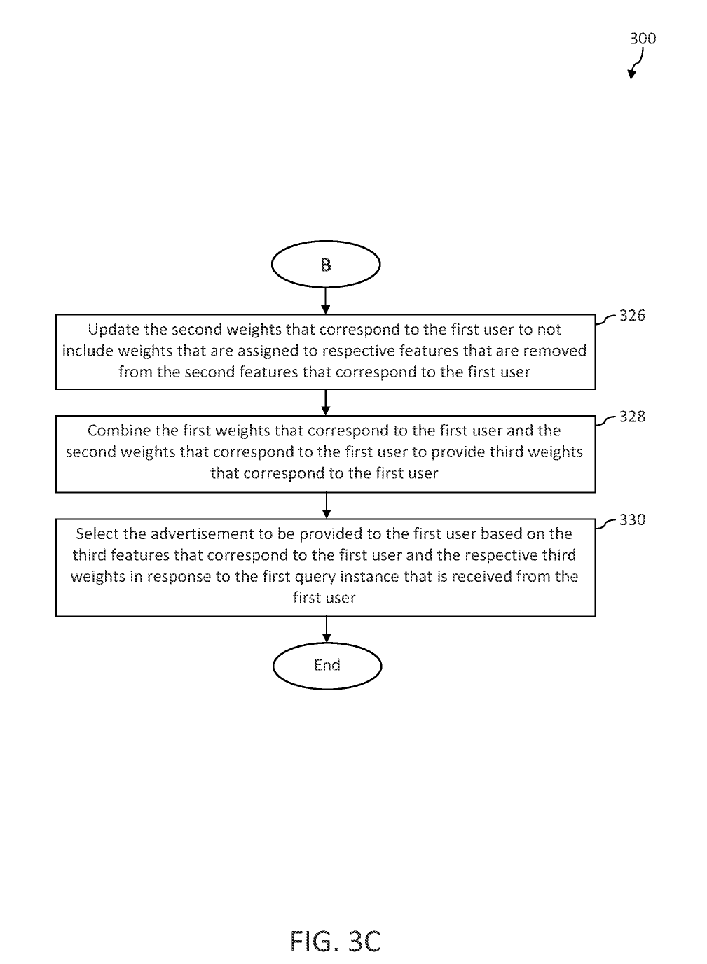

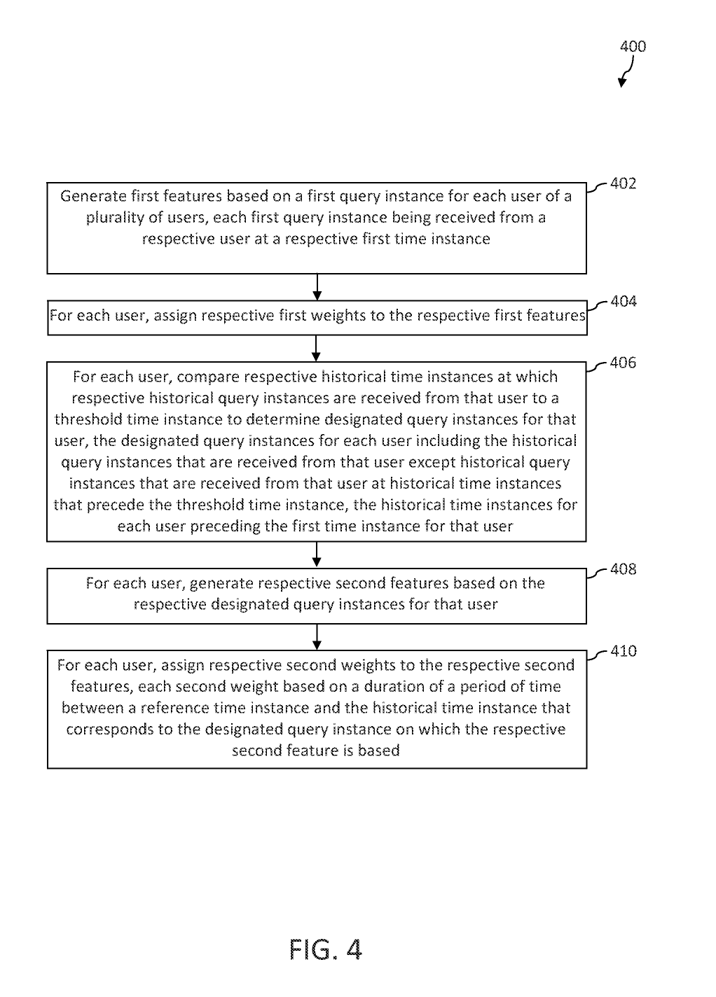

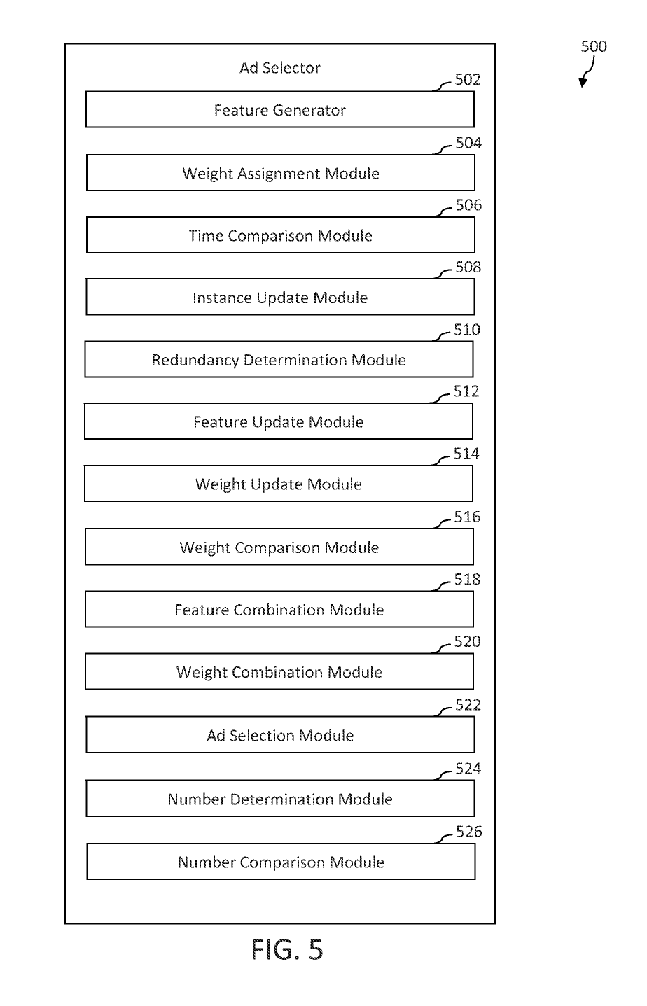

FIGS. 2A-2B depict respective portions of a flowchart 200 of an example method for selecting an advertisement in accordance with an embodiment described herein. FIGS. 3A-3C depict respective portions of a flowchart 300 of another example method for selecting an advertisement in accordance with an embodiment described herein. FIG. 4 depicts a flowchart 400 of yet another example method for selecting an advertisement in accordance with embodiments described herein. Flowcharts 200, 300, and 400 may be performed by ad selector 110 of ad network 100 shown in FIG. 1, for example. For illustrative purposes, flowcharts 200, 300, and 400 are described with respect to an ad selector 500 shown in FIG. 5, which is an example of an ad selector 110, according to an embodiment. As shown in FIG. 5, ad selector 500 includes a feature generator 502, a weight assignment module 504, a time comparison module 506, an instance update module 508, a redundancy determination module 510, a feature update module 512, a weight update module 514, a weight comparison module 516, a feature combination module 518, a weight combination module 520, an ad selection module 522, a number determination module 524, and a number comparison module 526. Further structural and operational embodiments will be apparent to persons skilled in the relevant art(s) based on the discussion regarding flowcharts 200, 300, and 400.

As shown in FIG. 2, the method of flowchart 200 begins at step 202. In step 202, first features are generated based on a first query instance that is received from a user at a first time instance. The first features may include any of a variety of types of features, including but not limited to keyword feature(s), key phrase feature(s), bid phrase feature(s), etc. In an example implementation, feature generator 502 generates the first features.

At step 204, first weights are assigned to the respective first features. In an example implementation, weight assignment module 504 assigns the first weights to the respective first features.

At step 206, each historical time instance at which a respective historical query instance is received from the user is compared to a threshold time instance to determine whether the respective historical time instance precedes the threshold time instance. For example, the threshold time instance may be defined to be a time instance that precedes a current time instance by a specified amount of time. In another example, the threshold time instance may be defined to be a set time instance that does not vary based on the current time. In an example implementation, time comparison module 506 compares each historical time instance at which a respective historical query instance is received from the user to the threshold time instance to determine whether the respective historical time instance precedes the threshold time instance.

At step 208, the historical query instances are updated to not include each historical query instance that is received from the user at a respective historical time instance that precedes the threshold time instance. It will be recognized that updating the historical query instances is intended to mean updating which of the query instances are to be taken into consideration for selecting an advertisement to be provided to the user. In accordance with step 208, historical query instances that are received from the user at historical time instances that precede the threshold time instance are not to be taken into consideration for selecting the advertisement. For instance, such historical query instances may be ignored. It will be further recognized that none of the historical query instances necessarily need to be deleted. However, in some example embodiments, a garbage collection operation is performed to delete each historical query instance that is received from the user at a respective historical time instance that precedes the threshold time instance from a session cache that stores the historical query instances. In an example implementation, instance update module 508 updates the historical query instances.

At step 210, second features are generated based on the historical query instances that are received from the user at respective historical time instances that precede the first time instance. The second features may include any of a variety of types of features, including but not limited to keyword feature(s), key phrase feature(s), bid phrase feature(s), etc. In an example implementation, feature generator 502 generates the second features.

At step 212, second weights are assigned to the respective second features. Each second weight is based on a duration of a period of time between a reference time instance and the historical time instance that corresponds to the historical query instance on which the respective second feature is based. For example, the reference time instance may be a current time instance, though the scope of the example embodiments is not limited in this respect. In an example implementation, weight assignment module 504 assigns the second weights to the respective second features.

At step 214, a determination is made that the second features include at least one redundant feature. The second features include multiple instances of each redundant feature. In an example implementation, redundancy determination module 510 determines that the second features include at least one redundant feature.

At step 216, the second features are updated to consolidate the multiple instances of each redundant feature into a respective common non-redundant feature. In an example implementation, feature update module 512 updates the second features to consolidate the multiple instances of each redundant feature into a respective common non-redundant feature.

At step 218, the second weights are updated to replace the weights of the respective instances of each redundant feature with a respective cumulative weight that is equal to a sum of the weights of the respective instances of the respective redundant feature. In an example implementation, weight update module 514 updates the second weights to replace the weights of the respective instances of each redundant feature with a respective cumulative weight that is equal to a sum of the weights of the respective instances of the respective redundant feature. Upon completion of step 218, flow continues to step 220, which is shown in FIG. 2B.

At step 220, each of the second weights is compared to a threshold weight to determine whether the respective second weight is less than the threshold weight. In an example implementation, weight comparison module 516 compares each of the second weights to the threshold weight to determine whether the respective second weight is less than the threshold weight.

At step 222, the second features are updated to not include each second feature to which a respective second weight is assigned that is less than the threshold weight. It will be recognized that updating the second features is intended to mean updating which of the second features are to be taken into consideration for selecting an advertisement to be provided to the user. In accordance with step 222, second features to which respective second weights are assigned that are less than the threshold weight are not to be taken into consideration for selecting the advertisement. For instance, such second features may be ignored. None of the second features necessarily need to be deleted, though each of the second features to which a respective second weight is assigned that is less than the threshold weight may be deleted during a garbage collection operation. In an example implementation, feature update module 512 updates the second features to not include each second feature to which a respective second weight is assigned that is less than the threshold weight.

At step 224, the second weights are updated to not include second weights that are less than the threshold weight. It will be recognized that updating the second weights is intended to mean updating which of the second weights are to be taken into consideration for selecting an advertisement to be provided to the user. In accordance with step 224, second weights that are less than the threshold weight are not to be taken into consideration for selecting the advertisement. For instance, such second weights may be ignored. None of the second weights necessarily need to be deleted, though each of the second weights that is less than the threshold weight may be deleted during a garbage collection operation. In an example implementation, weight update module 514 updates the second weights to not include second weights that are less than the threshold weight.

At step 226, the first and second features are combined to provide third features. In an example implementation, feature combination module 518 combines the first and second features to provide the third features.

At step 228, the first and second weights are combined to provide third weights that correspond to the respective third features. In an example implementation, weight combination module 520 combines the first and second weights to provide the third weights.

At step 230, a determination is made that the third features include at least one redundant feature. The third features include multiple instances of each redundant feature. In an example implementation, redundancy determination module 510 determines that the third features include at least one redundant feature.

At step 232, the third features are updated to consolidate the multiple instances of each redundant feature into a respective common non-redundant feature. In an example implementation, feature update module 512 updates the third features to consolidate the multiple instances of each redundant feature into a respective common non-redundant feature.

At step 234, the third weights are updated to replace the weights of the respective instances of each redundant feature with a respective cumulative weight that is equal to a sum of the weights of the respective instances of that redundant feature. In an example implementation, weight update module 514 updates the third weights to replace the weights of the respective instances of each redundant feature with a respective cumulative weight that is equal to a sum of the weights of the respective instances of that redundant feature.

At step 236, an advertisement is selected to be provided to the user based on the third features and the respective third weights in response to the first query instance. For example, the third weights may indicate an extent to which the respective third features are to be taken into consideration for purposes of selecting the advertisement. In an example implementation, ad selection module 522 selects the advertisement to be provided to the user.

In some example embodiments, one or more steps 202, 204, 206, 208, 210, 212, 214, 216, 218, 220, 222, 224, 226, 228, 230, 232, 234, and/or 236 of flowchart 200 may not be performed. Moreover, steps in addition to or in lieu of steps 202, 204, 206, 208, 210, 212, 214, 216, 218, 220, 222, 224, 226, 228, 230, 232, 234, and/or 236 may be performed.

As shown in FIG. 3, the method of flowchart 300 begins at step 302. In step 302, first features are generated based on a first query instance for each user of a plurality of users. Each first query instance is received from a respective user at a respective first time instance. For example, first features F1A may be generated for user A of the plurality of users based on a first query instance Q1A of user A, which is received at a respective first time instance T1A; first features F1B may be generated for user B of the plurality of users based on a first query instance Q1B of user B, which is received at a respective first time instance T1B; first features F1C may be generated for user C of the plurality of users based on a first query instance Q1C of user C, which is received at a respective first time instance T1C, and so on. In an example implementation, feature generator 502 generates the first features.

At step 304, for each user, respective first weights are assigned to the respective first features. In accordance with the example mentioned above, first weights W1A may be assigned to respective first features F1A; first weights W1B may be assigned to respective first features F1B; first weights W1C may be assigned to respective first features F1C, and so on. In an example implementation, weight assignment module 504 assigns the respective first weights to the respective first features for each user.

At step 306, for each user, respective second features are generated based on respective historical query instances that are received from that user at respective historical time instances that precede the respective first time instance. In accordance with the example mentioned above, second features F2A may be generated for user A based on historical query instances H1A that are received from user A at respective historical time instances TH_A that precede the respective first time instance T1A; second features F2B may be generated for user B based on historical query instances H1B that are received from user B at respective historical time instances TH_B that precede the respective first time instance T1B; second features F2C may be generated for user C based on historical query instances H1C that are received from user C at respective historical time instances TH_C that precede the respective first time instance T1C, and so on. In an example implementation, feature generator 502 generates the respective second features for each user.

At step 308, for each user, respective second weights are assigned to the respective second features. Each second weight is based on a duration of a period of time between a reference time instance and the historical time instance that corresponds to the historical query instance on which the respective second feature is based. In accordance with the example mentioned above, second weights W2A may be assigned to respective second features F2A; second weights W2B may be assigned to respective second features F2B; second weights W2C may be assigned to respective second features F2C, and so on. In an example implementation, weight assignment module 504 assigns the respective second weights to the respective second features for each user.

At step 310, for each user, each second weight that corresponds to that user is compared to a threshold weight to determine whether the respective weight is less than the threshold weight. In accordance with the example mentioned above, each of the second weights W2A for user A, each of the second weights W2B for user B, each of the second weights S2C for user C, and so on may be compared to the threshold weight. In an example implementation, weight comparison module 516 compares each second weight that corresponds to each user to a threshold weight to determine whether the respective weight is less than the threshold weight.

At step 312, for each user, the second features that correspond to that user are updated to not include each feature to which a respective second weight is assigned that is less than the threshold weight. In accordance with the example mentioned above, the second features F2A which correspond to user A, the second features F2B which correspond to user B, the second features F2C which correspond to user C, and so on may be updated to not include features to which respective second weights W2A, W2B, W2C, etc. are assigned that are less than the threshold weight. In an example implementation, feature update module 512 updates the second features that correspond to each user to not include each feature to which a respective second weight is assigned that is less than the threshold weight. Upon completion of step 312, flow continues to step 314, which is shown in FIG. 3B.

At step 314, for each user, the second weights that correspond to that user are updated to not include second weights that are less than the threshold weight. In accordance with the example mentioned above, the second weights W2A which correspond to user A, the second weights W2B which correspond to user B, the second weights W2C which correspond to user C, and so on may be updated to not include respective second weights W2A, W2B, W2C, etc. that are less than the threshold weight. In an example implementation, weight update module 514 updates the second weights that correspond to each user to not include second weights that are less than the threshold weight.

At step 316, for each user, the first and second features that correspond to that user are combined to provide third features that correspond to that user. In accordance with the example mentioned above, features F1A and F2A may be combined to provide third features F3A, which correspond to user A; features F1B and F2B may be combined to provide third features F3B, which correspond to user B; features F1C and F2C may be combined to provide third features F3C, which correspond to user C, and so on. In an example implementation, feature combination module 518 combines the first and second features that correspond to each user to provide third features that correspond to that user.

At step 318, for each feature that is included in the third features that correspond to a first user of the plurality of users, a number of the users is determined for which third features that correspond to the respective users include that feature. In accordance with the example mentioned above, for each of the third features F3A, which correspond to user A, a number of the users A, B, C, etc. for which respective third features F3A, F3B, F3C, etc. include that feature may be determined. In an example implementation, number determination module 524 determines the number of the users for each feature that is included in the third features that correspond to the first user.

At step 320, the number that is determined for each feature that is included in the third features that correspond to the first user is compared to a number threshold. In accordance with the example mentioned above, each of the numbers that is determined for each of the respective third features F3A may be compared to the number threshold. In an example implementation, number comparison module 526 compares the number that is determined for each feature that is included in the third features that correspond to the first user to the number threshold.

At step 322, for each number that is less than the number threshold, the corresponding feature is removed from the second features that correspond to the first user to provide revised second features. In accordance with the example mentioned above, for each number that is less than the number threshold, the corresponding feature may be removed from second features F2A, which correspond to user A, to provide revised second features F2 revised. In an example implementation, feature update module 512 removes each feature that corresponds to a number that is less than the number threshold from the second features that correspond to the first user to provide the revised second features.

At step 324, the third features that correspond to the first user are updated to include a combination of the first features that correspond to the first user and the revised second features. In accordance with the example mentioned above, third features F3A, which correspond to user A, may be updated to include a combination of features F1A and F2 revised. In an example implementation, feature update module 512 updates the third features that correspond to the first user to include the combination of the first features that correspond to the first user and the revised second features. Upon completion of step 324, flow continues to step 326, which is shown in FIG. 3C.

At step 326, the second weights that correspond to the first user are updated to not include weights that are assigned to respective features that are removed from the second features that correspond to the first user. In accordance with the example mentioned above, second weights W2A, which correspond to user A, may be updated to not include weights that are assigned to respective features that are removed from second features F2A. In an example implementation, weight update module 514 updates the second weights that correspond to the first user to not include weights that are assigned to respective features that are removed from the second features that correspond to the first user.

At step 328, the first weights that correspond to the first user and the second weights that correspond to the first user are combined to provide third weights that correspond to the first user. In accordance with the example mentioned above, weights W1A and W2A, which correspond to user A, may be combined to provide third weights W3A, which correspond to user A. In an example implementation, weight combination module 520 combine the first weights that correspond to the first user and the second weights that correspond to the first user to provide the third weights that correspond to the first user.

At step 330, the advertisement to be provided to the first user is selected based on the third features that correspond to the first user and the respective third weights in response to the first query instance that is received from the first user. In accordance with the example mentioned above, the advertisement may be selected to be provided to user A based on third features F3A and third weights W3A in response to the first query instance Q1A, which is received from user A. In an example implementation, ad selection module 522 selects the advertisement to be provided to the first user.

In some example embodiments, one or more steps 302, 304, 306, 308, 310, 312, 314, 316, 318, 320, 322, 324, 326, 328, and/or 330 of flowchart 300 may not be performed. Moreover, steps in addition to or in lieu of steps 302, 304, 306, 308, 310, 312, 314, 316, 318, 320, 322, 324, 326, 328, and/or 330 may be performed.

As shown in FIG. 4, the method of flowchart 400 begins at step 402. In step 402, first features are generated based on a first query instance for each user of a plurality of users. Each first query instance is received from a respective user at a respective first time instance. In an example implementation, feature generator 502 generates the first features.

At step 404, for each user, respective first weights are assigned to the respective first features. In an example implementation, weight assignment module 504 assigns the respective first weights to the respective first features for each user.

At step 406, for each user, respective historical time instances at which respective historical query instances are received from that user are compared to a threshold time instance to determine designated query instances for that user. The designated query instances for each user include the historical query instances that are received from that user except historical query instances that are received from that user at historical time instances that precede the threshold time instance. The historical time instances for each user precede the first time instance for that user. In an example implementation, time comparison module 506 compares historical time instances at which respective historical query instances are received from each user to the threshold time instance to determine the designated query instances for that user.

At step 408, for each user, respective second features are generated based on the respective designated query instances for that user. In an example implementation, feature generation module 502 generates the respective second features for each user based on the respective designated query instances for that user.

At step 410, for each user, respective second weights are assigned to the respective second features. Each second weight is based on a duration of a period of time between a reference time instance and the historical time instance that corresponds to the designated query instance on which the respective second feature is based. In an example implementation, weight assignment module 504 assigns the respective second weights to the respective second features for each user.

In some example embodiments, one or more steps 402, 404, 406, 408, and/or 410 of flowchart 400 may not be performed. Moreover, steps in addition to or in lieu of steps 402, 404, 406, 408, and/or 410 may be performed.

It will be recognized that ad selector 500 may not include one or more of feature generator 502, weight assignment module 504, time comparison module 506, instance update module 508, redundancy determination module 510, feature update module 512, weight update module 514, weight comparison module 516, feature combination module 518, weight combination module 520, ad selection module 522, number determination module 524, and/or number comparison module 526. Furthermore, ad selector 500 may include modules in addition to or in lieu of feature generator 502, weight assignment module 504, time comparison module 506, instance update module 508, redundancy determination module 510, feature update module 512, weight update module 514, weight comparison module 516, feature combination module 518, weight combination module 520, ad selection module 522, number determination module 524, and/or number comparison module 526.

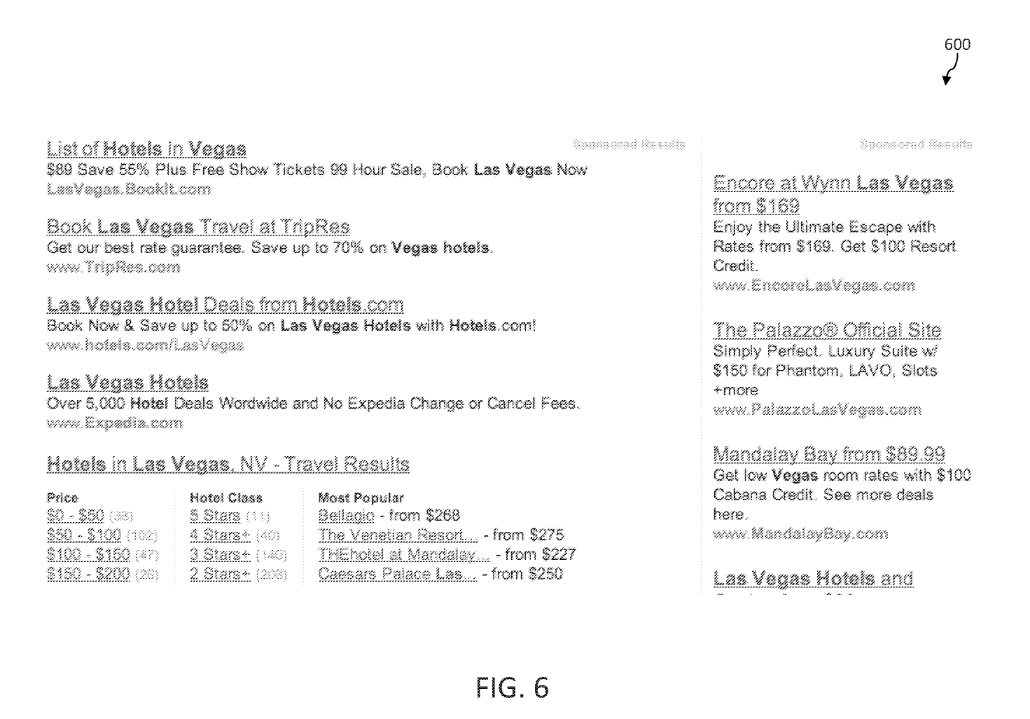

Some differences between conventional techniques for selecting ads and techniques described herein that use same session queries to select ads are illustrated in FIGS. 6-8. The search queries that are described with respect to FIGS. 6-8 are successive queries that define a session of the user. FIG. 6 shows some example advertisements 600 that are selected to be provided to a user in response to the user issuing a query of “Las Vegas hotels” in accordance with an embodiment described herein. Assume for purposes of illustration that the query “Las Vegas hotels” is the first query of the user's session. If the user were to issue a second query of “restaurants in strip”, the advertisements that are selected to be provided to the user may differ substantially, depending on whether the selection of the advertisements takes into consideration same session queries. In fact, it is possible that no advertisements may be selected to be provided to the user in response to the second query.

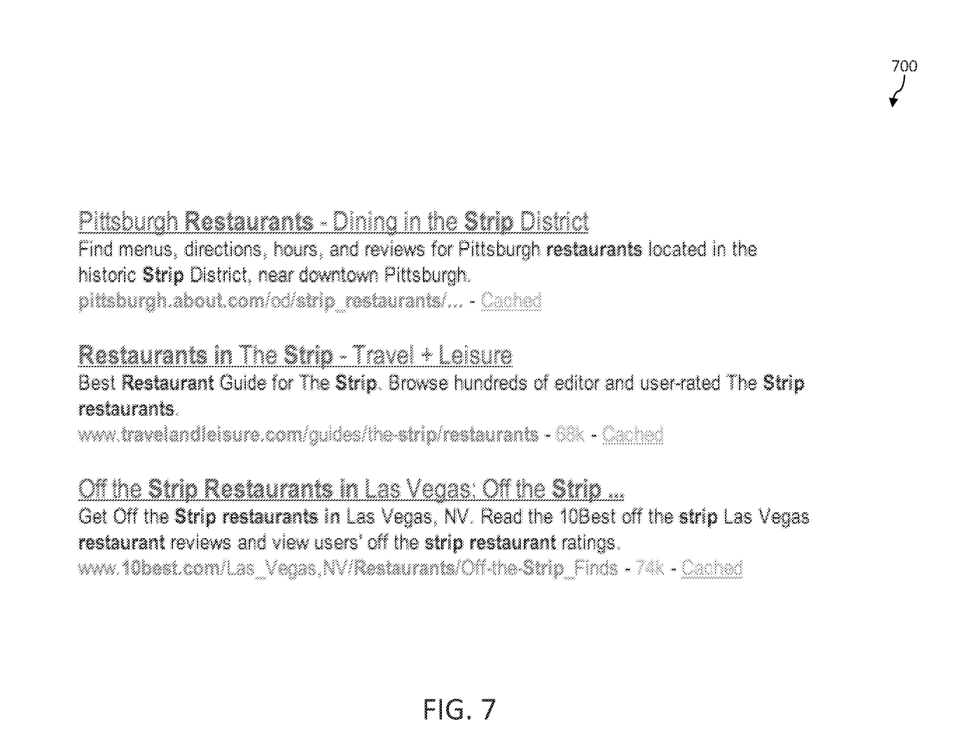

FIG. 7 illustrates absence of advertisements when same session queries are not used to select advertisements in accordance with an embodiment described herein. As shown in FIG. 7, algorithmic results 700 are provided to the user in response to the user's second query of “restaurants in strip”, but no advertisements are displayed.

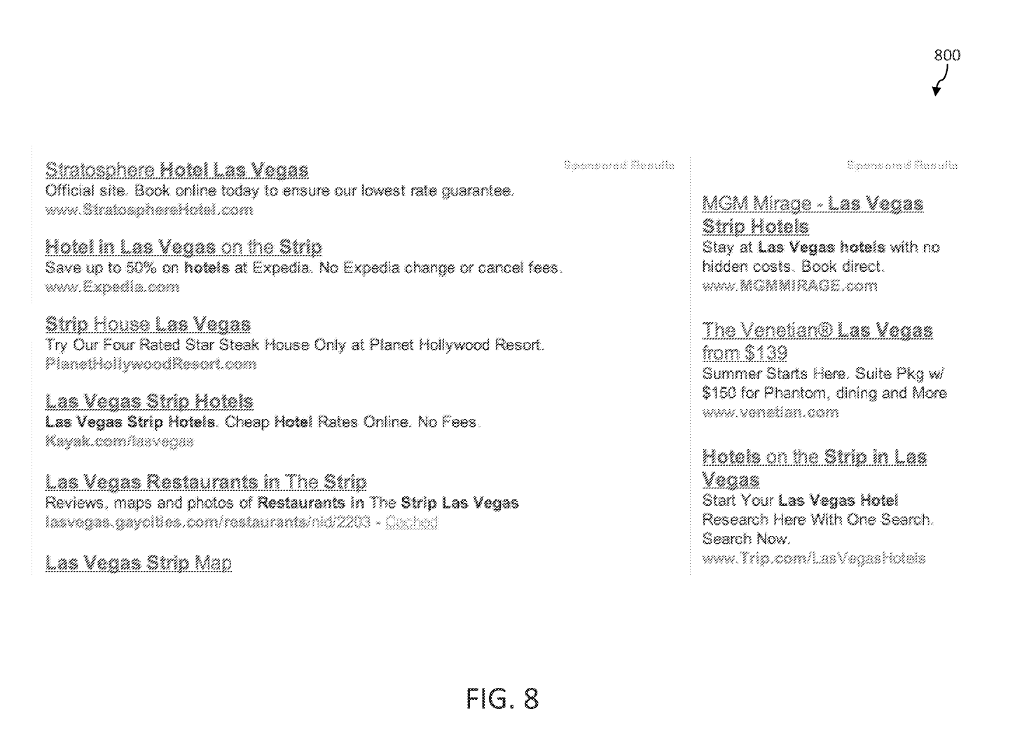

FIG. 8 shows some example advertisements 800 that are selected to be provided to the user in response to the user's second query of “restaurants in strip” when same session queries are taken into consideration in accordance with an embodiment described herein. In accordance with this example embodiment, features that are generated based on the first query of “Las Vegas hotels” are combined with features that are generated based on the second query of “restaurants in strip”. Advertisements 800 are selected to be provided to the user based on the combined features.

### III. Other Example Embodiments

Ad selector 110, search engine module 112, feature generator 502, weight assignment module 504, time comparison module 506, instance update module 508, redundancy determination module 510, feature update module 512, weight update module 514, weight comparison module 516, feature combination module 518, weight combination module 520, ad selection module 522, number determination module 524, and number comparison module 526 may be implemented in hardware, software, firmware, or any combination thereof.

For example, ad selector 110, search engine module 112, feature generator 502, weight assignment module 504, time comparison module 506, instance update module 508, redundancy determination module 510, feature update module 512, weight update module 514, weight comparison module 516, feature combination module 518, weight combination module 520, ad selection module 522, number determination module 524, and/or number comparison module 526 may be implemented as computer program code configured to be executed in one or more processors.

In another example, ad selector 110, search engine module 112, feature generator 502, weight assignment module 504, time comparison module 506, instance update module 508, redundancy determination module 510, feature update module 512, weight update module 514, weight comparison module 516, feature combination module 518, weight combination module 520, ad selection module 522, number determination module 524, and/or number comparison module 526 may be implemented as hardware logic/electrical circuitry.

### IV. Example Computer Implementation

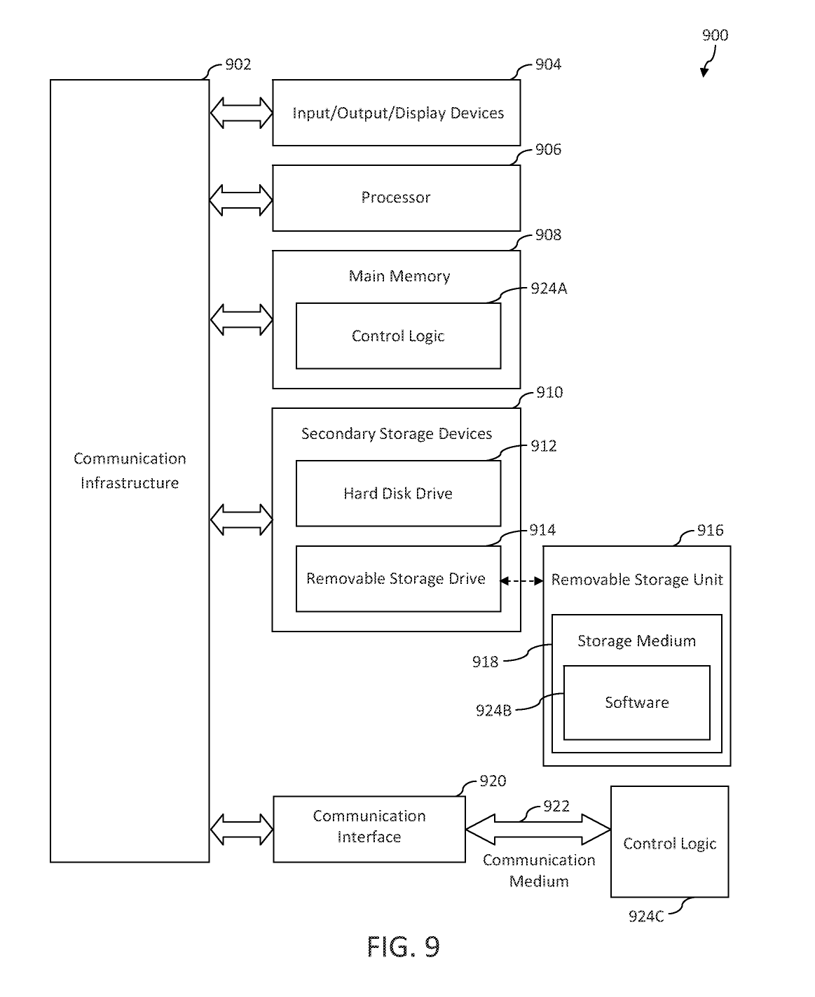

The embodiments described herein, including systems, methods/processes, and/or apparatuses, may be implemented using well known servers/computers, such as computer 900 shown in FIG. 9. For instance, elements of example ad network 100, including any of the user systems 102A-102M, any of the publisher servers 104A-104N, advertiser system 108, and ad serving system 106 depicted in FIG. 1 and elements thereof, each of the steps of flowchart 200 depicted in FIGS. 2A-2B, each of the steps of flowchart 300 depicted in FIGS. 3A-3C, and each of the steps of flowchart 400 depicted in FIG. 4 can each be implemented using one or more computers 900.

Computer 900 can be any commercially available and well known computer capable of performing the functions described herein, such as computers available from International Business Machines, Apple, Sun, HP, Dell, Cray, etc. Computer 900 may be any type of computer, including a desktop computer, a server, etc.

As shown in FIG. 9, computer 900 includes one or more processors (e.g., central processing units (CPUs)), such as processor 906. Processor 906 may include ad selector 110 and/or search engine module 112 of FIG. 1; feature generator 502, weight assignment module 504, time comparison module 506, instance update module 508, redundancy determination module 510, feature update module 512, weight update module 514, weight comparison module 516, feature combination module 518, weight combination module 520, ad selection module 522, number determination module 524, and/or number comparison module 526 of FIG. 5; or any portion or combination thereof, for example, though the scope of the embodiments is not limited in this respect. Processor 906 is connected to a communication infrastructure 902, such as a communication bus. In some embodiments, processor 906 can simultaneously operate multiple computing threads.

Computer 900 also includes a primary or main memory 908, such as a random access memory (RAM). Main memory has stored therein control logic 924A (computer software), and data.

Computer 900 also includes one or more secondary storage devices 910. Secondary storage devices 910 include, for example, a hard disk drive 912 and/or a removable storage device or drive 914, as well as other types of storage devices, such as memory cards and memory sticks. For instance, computer 900 may include an industry standard interface, such as a universal serial bus (USB) interface for interfacing with devices such as a memory stick. Removable storage drive 914 represents a floppy disk drive, a magnetic tape drive, a compact disk drive, an optical storage device, tape backup, etc.

Removable storage drive 914 interacts with a removable storage unit 916. Removable storage unit 916 includes a computer useable or readable storage medium 918 having stored therein computer software 924B (control logic) and/or data. Removable storage unit 916 represents a floppy disk, magnetic tape, compact disc (CD), digital versatile disc (DVD), Blue-ray disc, optical storage disk, memory stick, memory card, or any other computer data storage device. Removable storage drive 914 reads from and/or writes to removable storage unit 916 in a well known manner.

Computer 900 also includes input/output/display devices 904, such as monitors, keyboards, pointing devices, etc.

Computer 900 further includes a communication or network interface 920. Communication interface 920 enables computer 900 to communicate with remote devices. For example, communication interface 920 allows computer 900 to communicate over communication networks or mediums 922 (representing a form of a computer useable or readable medium), such as local area networks (LANs), wide area networks (WANs), the Internet, etc. Network interface 920 may interface with remote sites or networks via wired or wireless connections. Examples of communication interface 922 include but are not limited to a modem, a network interface card (e.g., an Ethernet card), a communication port, a Personal Computer Memory Card International Association (PCMCIA) card, etc.

Control logic 924C may be transmitted to and from computer 900 via the communication medium 922.

Any apparatus or manufacture comprising a computer useable or readable medium having control logic (software) stored therein is referred to herein as a computer program product or program storage device. This includes, but is not limited to, computer 900, main memory 908, secondary storage devices 910, and removable storage unit 916. Such computer program products, having control logic stored therein that, when executed by one or more data processing devices, cause such data processing devices to operate as described herein, represent embodiments of the invention.

For example, each of the elements of example ad selector 110 and search engine module 112, each depicted in FIG. 1; feature generator 502, weight assignment module 504, time comparison module 506, instance update module 508, redundancy determination module 510, feature update module 512, weight update module 514, weight comparison module 516, feature combination module 518, weight combination module 520, ad selection module 522, number determination module 524, and number comparison module 526, each depicted in FIG. 5; each of the steps of flowchart 200 depicted in FIG. 2; each of the steps of flowchart 300 depicted in FIG. 3; and each of the steps of flowchart 400 depicted in FIG. 4 can be implemented as control logic that may be stored on a computer useable medium or computer readable medium, which can be executed by one or more processors to operate as described herein.

### V. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method comprising:
generating a first plurality of features based on a first query instance that is received from a first user at a first time instance;
assigning a first plurality of weights to the first plurality of respective features;
generating a second plurality of features based on a plurality of historical query instances that are received from the first user at a plurality of respective historical time instances that precede the first time instance;
assigning a second plurality of weights to the second plurality of respective features, each weight of the second plurality of weights based on a duration of a period of time between a reference time instance and the historical time instance that corresponds to the historical query instance on which the respective feature of the second plurality of features is based;
comparing each weight of the second plurality of weights to a threshold weight to determine whether the respective weight is less than the threshold weight;
updating the second plurality of features to not include each feature to which a respective weight of the second plurality of weights is assigned that is less than the threshold weight;
updating the second plurality of weights to not include weights of the second plurality of weights that are less than the threshold weight;
combining the first plurality of features and the second plurality of features to provide a third plurality of features;
combining the first plurality of weights and the second plurality of weights to provide a third plurality of weights that corresponds to the third plurality of respective features; and
selecting an advertisement to be provided to the first user based on the third plurality of features and the third plurality of respective weights in response to the first query instance.

2. The method of claim 1, further comprising:
comparing each historical time instance of the plurality of historical time instances to a threshold time instance to determine whether the respective historical time instance precedes the threshold time instance; and
updating the plurality of historical query instances to not include each historical query instance that is received from the first user at a respective historical time instance that precedes the threshold time instance.

3. The method of claim 1, further comprising:
determining that the second plurality of features includes at least one redundant feature, the second plurality of features including multiple instances of each redundant feature;
updating the second plurality of features to consolidate the multiple instances of each redundant feature into a respective common non-redundant feature; and
updating the second plurality of weights to replace the weights of the respective instances of each redundant feature with a respective cumulative weight that is equal to a sum of the weights of the respective instances of the respective redundant feature;
wherein comparing each weight of the second plurality of weights to the threshold weight comprises:
comparing each weight of the second plurality of weights to the threshold weight in response to updating the second plurality of weights to replace the weights of the respective instances of each redundant feature with a respective cumulative weight that is equal to a sum of the weights of the respective instances of the respective redundant feature.

4. The method of claim 1, further comprising:
determining that the third plurality of features includes at least one redundant feature, the third plurality of features including multiple instances of each redundant feature;
updating the third plurality of features to consolidate the multiple instances of each redundant feature into a respective common non-redundant feature; and
updating the third plurality of weights to replace the weights of the respective instances of each redundant feature with a respective cumulative weight that is equal to a sum of the weights of the respective instances of that redundant feature;
wherein selecting the advertisement comprises:
selecting the advertisement to be provided to the first user in response to updating the third plurality of features and further in response to updating the third plurality of weights.

5. The method of claim 1, wherein generating the first plurality of features comprises:
generating a first plurality of features based on a first query instance for each user of a plurality of users that includes the first user, each first query instance being received from a respective user of the plurality of users at a respective first time instance;
wherein assigning the first plurality of weights comprises:
for each user of the plurality of users, assigning a respective first plurality of weights to the respective first plurality of respective features;
wherein generating the second plurality of features comprises:
for each user of the plurality of users, generating a respective second plurality of features based on a respective plurality of historical query instances that are received from that user at a respective plurality of historical time instances that precede the respective first time instance;
wherein the first query instance of the first user is same as a query instance in at least each of the pluralities of historical query instances of the plurality of users other than the first user;
wherein assigning the second plurality of weights comprises:
for each user of the plurality of users, assigning a respective second plurality of weights to the respective second plurality of features, each weight of the respective second plurality of weights based on a duration of a period of time between the reference time instance and the historical time instance that corresponds to the historical query instance on which the respective feature of the respective second plurality of features is based;
wherein comparing each weight of the second plurality of weights to the threshold weight comprises:
for each user of the plurality of users, comparing each weight of the respective second plurality of weights to the threshold weight to determine whether the respective weight is less than the threshold weight;
wherein updating the second plurality of features to not include each feature to which a respective weight of the second plurality of weights is assigned that is less than the threshold weight comprises:
for each user of the plurality of users, updating the respective second plurality of features to not include each feature to which a respective weight of the respective second plurality of weights is assigned that is less than the threshold weight;
wherein updating the second plurality of weights to not include weights of the second plurality of weights that are less than the threshold weight comprises:
for each user of the plurality of users, updating the respective second plurality of weights to not include weights of the respective second plurality of weights that are less than the threshold weight;
wherein combining the first plurality of features and the second plurality of features comprises:
for each user of the plurality of users, combining the respective first plurality of features and the respective second plurality of features to provide a respective third plurality of features;
for each feature that is included in the third plurality of features that corresponds to the first user, determining a number of the third pluralities of features that include that feature;
comparing the number that is determined for each feature that is included in the third plurality of features that corresponds to the first user to a number threshold;
for each number that is less than the number threshold, removing the corresponding feature from the second plurality of features that corresponds to the first user to provide a revised second plurality of features;
updating the third plurality of features that corresponds to the first user to include a combination of the first plurality of features that corresponds to the first user and the revised second plurality of features; and
updating the second plurality of weights that corresponds to the first user to not include weights that are assigned to respective features that are removed from the second plurality of features that corresponds to the first user;
wherein combining the first plurality of weights and the second plurality of weights comprises:
combining the first plurality of weights that corresponds to the first user and the second plurality of weights that corresponds to the first user to provide the third plurality of weights that corresponds to the first user; and
wherein selecting the advertisement comprises:
selecting the advertisement to be provided to the first user based on the third plurality of features that corresponds to the first user and the third plurality of respective weights in response to the first query instance that is received from the first user.

6. A method comprising:
generating a first plurality of features based on a first query instance that is received from a first user at a first time instance;
assigning a first plurality of weights to the first plurality of respective features;
comparing each historical time instance of a plurality of historical time instances at which a plurality of respective historical query instances are received from the first user to a threshold time instance to determine a plurality of designated query instances, the plurality of designated query instances including the plurality of historical query instances except historical query instances of the plurality of historical query instances that are received from the first user at historical time instances that precede the threshold time instance, the plurality of historical time instances preceding the first time instance;
generating a second plurality of features based on the plurality of designated query instances;
assigning a second plurality of weights to the second plurality of respective features, each weight of the second plurality of weights based on a duration of a period of time between a reference time instance and the historical time instance that corresponds to the designated query instance on which the respective feature of the second plurality of features is based;
combining the first plurality of features and the second plurality of features to provide a third plurality of features;
combining the first plurality of weights and the second plurality of weights to provide a third plurality of weights that corresponds to the third plurality of respective features; and
selecting an advertisement to be provided to the first user based on the third plurality of features and the third plurality of respective weights in response to the first query instance.

7. The method of claim 6, further comprising:
comparing each weight of the second plurality of weights to a threshold weight to determine whether the respective weight is less than the threshold weight;
updating the second plurality of features to not include each feature to which a respective weight of the second plurality of weights is assigned that is less than the threshold weight; and
updating the second plurality of weights to not include weights of the second plurality of weights that are less than the threshold weight;
wherein combining the first plurality of features and the second plurality of features comprises:
combining the first plurality of features and the second plurality of features in response to updating the second plurality of features to not include each feature to which a respective weight of the second plurality of weights is assigned that is less than the threshold weight; and
wherein combining the first plurality of weights and the second plurality of weights comprises:
combining the first plurality of weights and the second plurality of weights in response to updating the second plurality of weights.

8. The method of claim 6, further comprising:
determining that the second plurality of features includes at least one redundant feature, the second plurality of features including multiple instances of each redundant feature;
updating the second plurality of features to consolidate the multiple instances of each redundant feature into a respective common non-redundant feature; and
updating the second plurality of weights to replace the weights of the respective instances of each redundant feature with a respective cumulative weight that is equal to a sum of the weights of the respective instances of the respective redundant feature;
wherein combining the first plurality of features and the second plurality of features comprises:
combining the first plurality of features and the second plurality of features in response to updating the second plurality of features; and
wherein combining the first plurality of weights and the second plurality of weights comprises:
combining the first plurality of weights and the second plurality of weights in response to updating the second plurality of weights.

9. The method of claim 6, further comprising:
determining that the third plurality of features includes at least one redundant feature, the third plurality of features including multiple instances of each redundant feature;
updating the third plurality of features to consolidate the multiple instances of each redundant feature into a respective common non-redundant feature; and
updating the third plurality of weights to replace the weights of the respective instances of each redundant feature with a respective cumulative weight that is equal to a sum of the weights of the respective instances of the respective redundant feature;
wherein selecting the advertisement comprises:
selecting the advertisement to be provided to the first user in response to updating the third plurality of features and further in response to updating the third plurality of weights.

10. The method of claim 6, wherein generating the first plurality of features comprises:
generating a first plurality of features based on a first query instance for each user of a plurality of users that includes the first user, each first query instance being received from a respective user of the plurality of users at a respective first time instance;
wherein assigning the first plurality of weights comprises:
for each user of the plurality of users, assigning a respective first plurality of weights to the respective first plurality of respective features;
wherein comparing each historical time instance comprises:
for each user of the plurality of users, comparing each historical time instance of a respective plurality of historical time instances at which a respective plurality of historical query instances are received from a respective user to the threshold time instance to determine a respective plurality of designated query instances, each plurality of designated query instances including the respective plurality of historical query instances except historical query instances of the respective plurality of historical query instances that are received from the respective user at historical time instances that precede the threshold time instance, each plurality of historical time instances preceding the respective first time instance;
wherein generating the second plurality of features comprises:
for each user of the plurality of users, generating a respective second plurality of features based on a respective plurality of designated query instances;
wherein the first query instance of the first user is same as a query instance in at least each of the pluralities of designated query instances of the plurality of users other than the first user;
wherein assigning the second plurality of weights comprises:
for each user of the plurality of users, assigning a respective second plurality of weights to the respective second plurality of features, each weight of the respective second plurality of weights based on a duration of a period of time between the reference time instance and the historical time instance that corresponds to the designated query instance on which the respective feature of the respective second plurality of features is based;
wherein combining the first plurality of features and the second plurality of features comprises:
for each user of the plurality of users, combining the respective first plurality of features and the respective second plurality of features to provide a respective third plurality of features;
for each feature that is included in the third plurality of features that corresponds to the first user, determining a number of the third pluralities of features that include that feature;
comparing the number that is determined for each feature that is included in the third plurality of features that corresponds to the first user to a number threshold;
for each number that is less than the number threshold, removing the corresponding feature from the second plurality of features that corresponds to the first user to provide a revised second plurality of features;
updating the third plurality of features that corresponds to the first user to include a combination of the first plurality of features that corresponds to the first user and the revised second plurality of features; and
updating the second plurality of weights that corresponds to the first user to not include weights that are assigned to respective features that are removed from the second plurality of features that corresponds to the first user;
wherein combining the first plurality of weights and the second plurality of weights comprises:
combining the first plurality of weights that corresponds to the first user and the second plurality of weights that corresponds to the first user to provide the third plurality of weights that corresponds to the first user; and
wherein selecting the advertisement comprises:
selecting the advertisement to be provided to the first user based on the third plurality of features that corresponds to the first user and the third plurality of respective weights in response to the first query instance that is received from the first user.

11. A system comprising:
a feature generator configured to generate a first plurality of features based on a first query instance that is received from a first user at a first time instance, the feature generator further configured to generate a second plurality of features based on a plurality of historical query instances that are received from the first user at a plurality of respective historical time instances that precede the first time instance;
a weight assignment module configured to assign a first plurality of weights to the first plurality of respective features, the weight assignment module further configured to assign a second plurality of weights to the second plurality of respective features, each weight of the second plurality of weights based on a duration of a period of time between a reference time instance and the historical time instance that corresponds to the historical query instance on which the respective feature of the second plurality of features is based;
a weight comparison module configured to compare each weight of the second plurality of weights to a threshold weight to determine whether the respective weight is less than the threshold weight;
a feature update module configured to update the second plurality of features to not include each feature to which a respective weight of the second plurality of weights is assigned that is less than the threshold weight;
a weight update module configured to update the second plurality of weights to not include weights of the second plurality of weights that are less than the threshold weight;
a feature combination module configured to combine the first plurality of features and the second plurality of features to provide a third plurality of features;
a weight combination module configured to combine the first plurality of weights and the second plurality of weights to provide a third plurality of weights that corresponds to the third plurality of respective features; and
an ad selection module configured to select an advertisement to be provided to the first user based on the third plurality of features and the third plurality of respective weights in response to the first query instance.

12. The system of claim 11, further comprising:
a time comparison module configured to compare each historical time instance of the plurality of historical time instances to a threshold time instance to determine whether the respective historical time instance precedes the threshold time instance; and
an instance update module configured to update the plurality of historical query instances to not include each historical query instance that is received from the first user at a respective historical time instance that precedes the threshold time instance.

13. The system of claim 11, further comprising:
a redundancy determination module configured to determine whether the second plurality of features includes multiple instances of at least one redundant feature;
wherein the feature update module is further configured to update the second plurality of features to consolidate the multiple instances of each redundant feature into a respective common non-redundant feature;
wherein the weight update module is further configured to update the second plurality of weights to replace the weights of the respective instances of each redundant feature with a respective cumulative weight that is equal to a sum of the weights of the respective instances of the respective redundant feature; and
wherein the weight comparison module is configured to compare each weight of the second plurality of weights to the threshold weight in response to the second plurality of weights being updated to replace the weights of the respective instances of each redundant feature with a respective cumulative weight that is equal to a sum of the weights of the respective instances of the respective redundant feature.

14. The system of claim 11, further comprising:
a redundancy determination module configured to determine whether the third plurality of features includes multiple instances of at least one redundant feature;
wherein the feature update module is further configured to update the third plurality of features to consolidate the multiple instances of each redundant feature into a respective common non-redundant feature; and
wherein the weight update module is further configured to update the third plurality of weights to replace the weights of the respective instances of each redundant feature with a respective cumulative weight that is equal to a sum of the weights of the respective instances of that redundant feature;
wherein the ad selection module is configured to select the advertisement to be provided to the first user in response to the third plurality of features and the third plurality of weights being updated.

15. The system of claim 11, wherein the feature generator is configured to generate a first plurality of features based on a first query instance for each user of a plurality of users that includes the first user, each first query instance being received from a respective user of the plurality of users at a respective first time instance;
wherein the feature generator is further configured to generating, for each user of the plurality of users, a respective second plurality of features based on a respective plurality of historical query instances that are received from that user at a respective plurality of historical time instances that precede the respective first time instance;
wherein the first query instance of the first user is same as a query instance in at least each of the pluralities of historical query instances of the plurality of users other than the first user;
wherein the weight assignment module is configured to assign, for each user of the plurality of users, a respective first plurality of weights to the respective first plurality of respective features;
wherein the weight assignment module is further configured to assign, for each user of the plurality of users, a respective second plurality of weights to the respective second plurality of features, each weight of the respective second plurality of weights based on a duration of a period of time between the reference time instance and the historical time instance that corresponds to the historical query instance on which the respective feature of the respective second plurality of features is based;
wherein the weight comparison module is configured to compare, for each user of the plurality of users, each weight of the respective second plurality of weights to the threshold weight to determine whether the respective weight is less than the threshold weight;
wherein the feature update module is configured to update, for each user of the plurality of users, the respective second plurality of features to not include each feature to which a respective weight of the respective second plurality of weights is assigned that is less than the threshold weight;
wherein the weight update module is configured to update, for each user of the plurality of users, the respective second plurality of weights to not include weights of the respective second plurality of weights that are less than the threshold weight;
wherein the feature combination module is configured to combine, for each user of the plurality of users, the respective first plurality of features and the respective second plurality of features to provide a respective third plurality of features;
wherein the system further comprises:
a number determination module that is configured to determine, for each feature that is included in the third plurality of features that corresponds to the first user, a number of the third pluralities of features that include that feature; and
a number comparison module that is configured to compare the number that is determined for each feature that is included in the third plurality of features that corresponds to the first user to a number threshold;
wherein the feature update module is further configured to remove, for each number that is less than the number threshold, the corresponding feature from the second plurality of features that corresponds to the first user to provide a revised second plurality of features;
wherein the feature update module is further configured to update the third plurality of features that corresponds to the first user to include a combination of the first plurality of features that corresponds to the first user and the revised second plurality of features;
wherein the weight update module is further configured to update the second plurality of weights that corresponds to the first user to not include weights that are assigned to respective features that are removed from the second plurality of features that corresponds to the first user;
wherein the weight combination module is configured to combine the first plurality of weights that corresponds to the first user and the second plurality of weights that corresponds to the first user to provide the third plurality of weights that corresponds to the first user; and
wherein the ad selection module is configured to select the advertisement to be provided to the first user based on the third plurality of features that corresponds to the first user and the third plurality of respective weights in response to the first query instance that is received from the first user.

16. A system comprising:
a time comparison module configured to compare each historical time instance of a plurality of historical time instances at which a plurality of respective historical query instances are received from a first user to a threshold time instance to determine a plurality of designated query instances, the plurality of designated query instances including the plurality of historical query instances except historical query instances of the plurality of historical query instances that are received from the first user at historical time instances that precede the threshold time instance;
a feature generator configured to generate a first plurality of features based on a first query instance that is received from the first user at a first time instance, the feature generator further configured to generate a second plurality of features based on the plurality of designated query instances, the plurality of historical time instances preceding the first time instance;
a weight assignment module configured to assign a first plurality of weights to the first plurality of respective features, the weight assignment module further configured to assign a second plurality of weights to the second plurality of respective features, each weight of the second plurality of weights based on a duration of a period of time between a reference time instance and the historical time instance that corresponds to the designated query instance on which the respective feature of the second plurality of features is based;
a feature combination module configured to combine the first plurality of features and the second plurality of features to provide a third plurality of features;
a weight combination module configured to combine the first plurality of weights and the second plurality of weights to provide a third plurality of weights that corresponds to the third plurality of respective features; and
an ad selection module configured to select an advertisement to be provided to the first user based on the third plurality of features and the third plurality of respective weights in response to the first query instance.

17. The system of claim 16, further comprising:
a weight comparison module configured to compare each weight of the second plurality of weights to a threshold weight to determine whether the respective weight is less than the threshold weight;
a feature update module configured to update the second plurality of features to not include each feature to which a respective weight of the second plurality of weights is assigned that is less than the threshold weight; and
a weight update module configured to update the second plurality of weights to not include weights of the second plurality of weights that are less than the threshold weight;
wherein the feature combination module is configured to combine the first plurality of features and the second plurality of features in response to the second plurality of features being updated to not include each feature to which a respective weight of the second plurality of weights is assigned that is less than the threshold weight; and
wherein the weight combination module is configured to combine the first plurality of weights and the second plurality of weights in response to the second plurality of weights being updated.

18. The system of claim 16, further comprising:
a redundancy determination module configured to determine whether the second plurality of features includes multiple instances of at least one redundant feature;
a feature update module configured to update the second plurality of features to consolidate the multiple instances of each redundant feature into a respective common non-redundant feature; and
a weight update module configured to update the second plurality of weights to replace the weights of the respective instances of each redundant feature with a respective cumulative weight that is equal to a sum of the weights of the respective instances of the respective redundant feature;
wherein the feature combination module is configured to combine the first plurality of features and the second plurality of features in response to the second plurality of features being updated; and
wherein the weight combination module is configured to combine the first plurality of weights and the second plurality of weights in response to the second plurality of weights being updated.

19. The system of claim 16, further comprising:
a redundancy determination module configured to determine whether the third plurality of features includes multiple instances of at least one redundant feature;
a feature update module configured to update the third plurality of features to consolidate the multiple instances of each redundant feature into a respective common non-redundant feature; and
a weight update module configured to update the third plurality of weights to replace the weights of the respective instances of each redundant feature with a respective cumulative weight that is equal to a sum of the weights of the respective instances of the respective redundant feature;
wherein the ad selection module is configured to select the advertisement to be provided to the first user in response to the third plurality of features and the third plurality of weights being updated.

20. The system of claim 16, the time comparison module is configured to compare, for each user of a plurality of users that includes the first user, each historical time instance of a respective plurality of historical time instances at which a respective plurality of historical query instances are received from a respective user to the threshold time instance to determine a respective plurality of designated query instances, each plurality of designated query instances including the respective plurality of historical query instances except historical query instances of the respective plurality of historical query instances that are received from the respective user at historical time instances that precede the threshold time instance;
wherein the feature generator is configured to generate a first plurality of features based on a first query instance for each user of the plurality of users, each first query instance being received from a respective user of the plurality of users at a respective first time instance;
wherein the feature generator is further configured to generate, for each user of the plurality of users, a respective second plurality of features based on a respective plurality of designated query instances;
wherein the first query instance of the first user is same as a query instance in at least each of the pluralities of designated query instances of the plurality of users other than the first user;
wherein the weight assignment module is configured to assign, for each user of the plurality of users, a respective first plurality of weights to the respective first plurality of respective features;
wherein the weight assignment module is further configured to assign, for each user of the plurality of users, a respective second plurality of weights to the respective second plurality of features, each weight of the respective second plurality of weights based on a duration of a period of time between the reference time instance and the historical time instance that corresponds to the designated query instance on which the respective feature of the respective second plurality of features is based;
wherein the feature combination module is configured to combine, for each user of the plurality of users, the respective first plurality of features and the respective second plurality of features to provide a respective third plurality of features;
wherein the system further comprises:
a number determination module configured to determine, for each feature that is included in the third plurality of features that corresponds to the first user, a number of the third pluralities of features that include that feature;
a number comparison module configured to compare the number that is determined for each feature that is included in the third plurality of features that corresponds to the first user to a number threshold;
a feature update module configured to remove, for each number that is less than the number threshold, the corresponding feature from the second plurality of features that corresponds to the first user to provide a revised second plurality of features, the feature update module further configured to update the third plurality of features that corresponds to the first user to include a combination of the first plurality of features that corresponds to the first user and the revised second plurality of features; and
a weight update module configured to update the second plurality of weights that corresponds to the first user to not include weights that are assigned to respective features that are removed from the second plurality of features that corresponds to the first user;
wherein the feature combination module is configured to combine the first plurality of weights that corresponds to the first user and the second plurality of weights that corresponds to the first user to provide the third plurality of weights that corresponds to the first user; and
wherein the ad selection module is configured to select the advertisement to be provided to the first user based on the third plurality of features that corresponds to the first user and the third plurality of respective weights in response to the first query instance that is received from the first user.
